(19) United States
(12) Patent Application Publication
(10) Pub. No.: US 2012/0139148 A1
(43) Pub. Date: Jun. 7, 2012

(54) MANUFACTURING METHOD FOR DIFFUSER

(75) Inventors: Satoshi IIZUKA, Nara City (JP); Soichiro SHIBATA, Nara City (JP)

(73) Assignee: IIDZKA SEISAKUSHO CO., LTD., Yamatotakada City (JP)

(21) Appl. No.: 13/286,598

(22) Filed: Nov. 1, 2011

(30) Foreign Application Priority Data
Nov. 5, 2010 (JP) 2010-261741

(51) Int. Cl. B29C 43/14

(52) U.S. Cl. 264/108

(57) ABSTRACT

A manufacturing method for a diffuser includes a first process in which a cylindrical solid material with a fiber flow extending in an axial direction is forged to form a first shaped component which has disk-shaped top and bottom surfaces; a second process in which the first shaped component is rotated degrees and forged in a direction perpendicular to the axial direction to form a second shaped component which has a flange and a cylindrical portion; and a third process in which the second shaped component is press-formed in a direction perpendicular to the fiber flow to form a third shaped component which has a flange including a central hole portion and an outer edge engaging portion with a fiber flow extending in a radial direction, and a bottomed cylindrical portion including a communicating hole.

### PRIORITY RIGHT INFORMATION

The present application claims priority right based on Japanese Patent Application No. 2010-261741 (filed on Nov. 5, 2010) which is incorporated herein by reference as an integral part of the present application.

### BACKGROUND

1. Technical Field

The present invention relates to a manufacturing method for a diffuser in an airbag inflator used to inflate an airbag of a vehicle.

2. Related Art

Conventionally, a diffuser such as shown in FIG. 12 has been known as this type of diffuser for an airbag inflator.

As shown in FIG. 12, this diffuser 10A has a flange 10a with a central hole portion 10c and an outer edge engaging portion 10d, and a bottomed cylindrical portion 10b including a communicating hole 10e which is continuously provided at an axial end of the flange 10a and communicates with the above central hole portion 10c. The bottomed cylindrical portion 10b is structured to include two or more outlets 10f extending in a radial direction in a lower portion of the communicating hole 10e. The outer edge surface of the flange 10 is attached to an opening of a high-pressure gas container 11 by welding, while the outer circumferential portion of the bottomed cylindrical portion 10b is engagingly attached to an airbag 12.

As a method for manufacturing the above-described diffuser 10A, in order to increase yield and reduce cost, a cylindrical solid material 1A (wire rod cut to a specified length) with a fiber flow extending in an axial direction shown in FIG. 13(a) is used at the start. The cylindrical solid material 1A is forged first by using a multistage former in the axial direction such that a shape (b) in FIG. 13 is formed to have a shape (d) in FIG. 13 in a stepwise manner. Then, the cylindrical solid material is press-formed in the axial direction by using a vertical press such that the shape (d) in FIG. 13 is press-formed to have a shape (f) shown in FIG. 13 in a stepwise manner. More specifically, as shown in FIG. 13(f), an intermediate shaped component 9 is formed to have a flange 9a including a central hole portion 9c and an outer edge engaging portion 9d, and a bottomed cylindrical portion 9a including a communicating hole 9e which is continuously provided at an axial end of the flange 9a and communicates with the above central hole portion 9d. Then, a diffuser 10a as a final shaped component as shown in FIG. 12 is formed by trimming the outer peripheral surface of the flange of the intermediate shaped component 9 and by making, on the bottomed cylindrical portion 10b, two or more outlets 10f towards the communicating hole 10e.

### SUMMARY OF THE INVENTION

### Problems to be Solved by the Invention

However, according to the above-described manufacturing method for a diffuser, while it is possible on the one hand to improve yield and reduce cost because a cylindrical solid material 1A (wire rod cut to a specified length) with a fiber flow extending in an axial direction is used, the fiber flow extending in an axial direction is interrupted midway as shown in FIG. 12 because a trimming process is applied to the outer peripheral surface of the flange 61 of an intermediate shaped component . As a result, when the diffuser 10A is attached to the high-pressure gas container 11 by welding as shown in FIG. 12, a problem occurs that a high-pressure gas leaks from the portion where the fiber flow is interrupted, at a very small proportion such as in one in every several ten-thousand components.

The cause of this gas leak is a phenomenon where a very small amount of high pressure gas escapes with an extremely low probability along a fiber flow formed during a strengthening process by cold forging of a material (steel) and non-ferrous inclusions within the steel. As a result, at a portion where the fiber flow of a diffuser is interrupted, for example, a very small amount of high pressure gas escapes along the fiber flow from the portion where the fiber flow is interrupted, at a very small proportion such as in one in every several ten-thousand diffusers, due to the above-described phenomenon. With respect to this problem, after manufacture of diffusers, total inspection of the diffusers to be used is carried out to see whether or not gas leaks have occurred in portions where the fiber flow is interrupted, and only those having no gas leak are used. As a result, inspection requires some work and this in turn pushes up costs.

The occurrence of fiber flow arises inevitably with cold forging. Further, while non-ferrous inclusions in the material have been considerably improved along with advancement of steelmaking techniques, they have not been completely eliminated at present.

The present invention therefore has an object to provide a manufacturing method, with high yield at low cost, for a diffuser that is free from gas leakage by eliminating portions where fiber flow is interrupted.

### Means for Solving the Problems

The invention according to claim 1 of the present application is characterized by providing a method for manufacturing a diffuser comprising a flange including a central hole portion and an outer edge engaging portion, a bottomed cylindrical portion including a communicating hole which is continuously provided at an axial end of the flange, and a plurality of outlets extending in a radial direction to communicate with an airbag in a lower portion of the communicating hole of the bottomed cylindrical portion, the method comprising: a first process in which, by using a cylindrical solid material having a fiber flow extending in an axial direction in order to eliminate material loss, the cylindrical solid material is forged in an axial direction to form a first shaped component which has disk-shaped top and bottom surfaces and a flattened spindle-shape in side view; a second process in which the first shaped component is rotated 90 degrees to be placed horizontal, and the horizontally placed first shaped component is forged in a direction perpendicular to the axial direction to form a second shaped component which has a flange with the fiber flow extending in a radial direction and a cylindrical portion continuously provided at an axial end of the flange; and a third process in which the second shaped component is press-formed or forged in a direction perpendicular to the fiber flow to form a third shaped component which has a flange including a central hole portion and an outer edge engaging portion, and a bottomed cylindrical portion including a communicating hole which is continuously provided at an axial end of the flange and communicates with the central hole portion such that the fiber flow uninterruptedly flows in a substantial radial direction of the flange.

### Advantages of the Invention

In accordance with the manufacturing method for a diffuser described in claim 1 of the present invention, it is possible to perform forming with high yield at low cost because forging is performed in a sequential stepwise manner by using a cylindrical solid material with a fiber flow extending in an axial direction.

First, in a first process, the cylindrical solid material is forged in an axial direction to form a first shaped component which has disk-shaped top and bottom surfaces and a flattened spindle-shape in side view. Next, in a second process, the first shaped component is rotated 90 degrees to be placed horizontal, and the horizontally placed first shaped component is forged in a direction perpendicular to the axial direction to form a second shaped component which has a flange with the fiber flow extending in a radial direction and a cylindrical portion continuously provided at an axial end of the flange. Then, in a third process, the second shaped component is press-formed or forged in a direction perpendicular to the fiber flow to form a third shaped component which has a flange including a central hole portion and an outer edge engaging portion, and a bottomed cylindrical portion including a communicating hole which is continuously provided at an axial end of the flange and communicates with the central hole portion such that the fiber flow uninterruptedly flows in a substantially radial direction of the flange. Therefore, when a high-pressure gas container is attached to an outer surface of the flange, gas leakage from the flange and bottomed cylindrical portion can be completely prevented because of the uninterrupted fiber flow extending in a substantial radial direction. As a result, an inspection for a presence or absence of gas leakage at the flange and bottomed cylindrical portion after manufacture of the diffuser can be avoided. Not only because the inspection work can be avoided, but also because logical assurance is possible, the diffuser can be safely and reliably used while keeping the cost low.

### BRIEF DESCRIPTION OF THE DRAWINGS

FIG. 1 is a front view of a solid material used in a manufacturing method for a diffuser according to the present invention.

FIG. 2 is a front view of a shaped component which is formed by a former in a process after that shown in FIG. 1.

FIG. 3 is a front view of a shaped component which is formed by a former in a process after that shown in FIG. 2.

FIG. 4 is a front view of a first shaped component which is formed by a former in a process after that shown in FIG. 3.

FIG. 5 is a front view of the first shaped component rotated 90 degrees to be placed horizontal.

FIG. 6 is a front view of a second shaped component which is formed in a process after that shown in FIG. 5. FIG. 7 is a cross-sectional view of a shaped component which is formed in a process after that shown in FIG. 6.

FIG. 8 is a cross-sectional view of a shaped component which is formed in a process after that shown in FIG. 7.

FIG. 9 is a cross-sectional view of a shaped component which is formed in a process after that shown in FIG. 8.

FIG. 10 is a cross-sectional view of a shaped component which is formed in a process after that shown in FIG. 9.

FIG. 11 is a cross-sectional view of a final shaped component.

FIG. 12 is an explanatory drawing of conventional art.

FIG. 13 is an explanatory drawing of a manufacturing process of the conventional art.

### BEST MODE FOR CARRYING OUT THE INVENTION

A diffuser manufacturing method according to the present invention is described below based on the drawings.

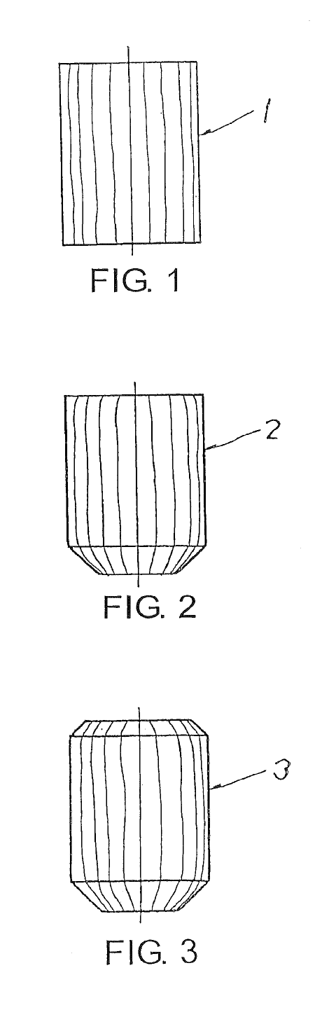

FIGS. 1 to 11 respectively show explanatory drawings of shapes for one embodiment of a manufacturing method of a diffuser according to the present invention. Each of the drawings shows a front view or cross-sectional view of a shaped component in each process.

FIG. 1 shows a cylindrical solid material 1 having a fiber flow extending in an axial direction. This solid material 1 may be a blank formed by cutting a wire rod to specified dimensions in advance, or a material formed by cutting, to specified dimensions, a sequentially supplied wire rod using a cutting machine at the time of forging by a former. Here, fiber flow is flowing in the axial direction (vertical direction in the drawing) as shown in FIG. 1.

Then, as shown in FIG. 2, the solid material 1 is forged in the axial direction by a die and a punch at a first forging station of a multistage former (not shown) resulting in one end, in the length direction, having an end surface shaped in an upsetting process.

Further, in FIG. 3, the solid material 2 to which the upsetting process was applied is forged further in the axial direction by a die and a punch at a second forging station of the multistage former resulting in the other end, in the length direction, having an end surface shaped in an upsetting process.

Here, as shown in FIG. 2, the fiber flow uninterruptedly flows substantially in the axial direction.

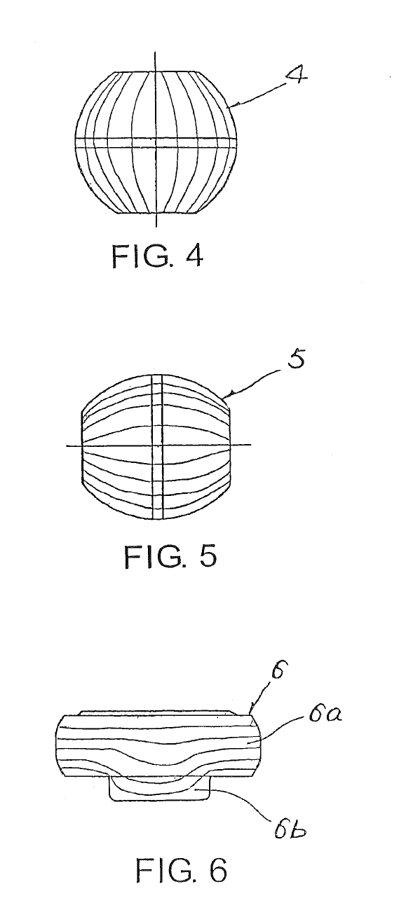

In FIG. 4, the solid material 3 to which the upsetting process was applied is forged in the axial direction by a die and a punch at a third forging station of the multistage former resulting in a first shaped component 4 which has disk-shaped top and bottom surfaces and a flattened spindle-shape expanded at a middle peripheral portion as shown in FIG. 4 (first process).

Here, as shown in FIG. 4, the fiber flow of the first shaped component 4 uninterruptedly flows in a substantially axial direction.

Then, the first shaped component 4 is press-formed by an upper die and a lower die from a direction perpendicular to the axial direction shown in FIG. 5 during transportation to a fourth forging station. The first shaped component 4 is rotated 90 degrees such that the axial direction, or fiber flow, is placed horizontal.

Then, at the fourth forging station, the horizontally placed first shaped component 5 is first formed to be a second shaped component 6 which has a flange 6a with the fiber flow extending in a radial direction and a cylindrical portion 6b which is continuously formed from a center portion at an axial end of the flange 6a as shown in FIG. 6 (second process).

Here, as shown in FIG. 6, the fiber flow of the second shaped component 6 uninterruptedly flows in a substantially radial direction (horizontal in the drawing) of the flange 6a.

Then, the second shaped component 6 which was formed by the multistage former as described above is sent to a vertical press (not shown) where the second shaped component 6 is press-formed in a stepwise manner by the vertical press. Ata first press station, the second shaped component 6 is first press-formed by upper and lower dies in a direction perpendicular to the fiber flow such that an intermediate shaped component 7 is formed to have a flange 7a with a central hole portion 7c and a cylindrical portion 7b formed continuously from a center portion at an axial end of the flange 7a as shown in FIG. 7.

Here, as shown in FIG. 7, the fiber flow of the intermediate shaped component 7 uninterruptedly flows in a substantially radial direction (horizontal in the drawing) of the flange 7a.

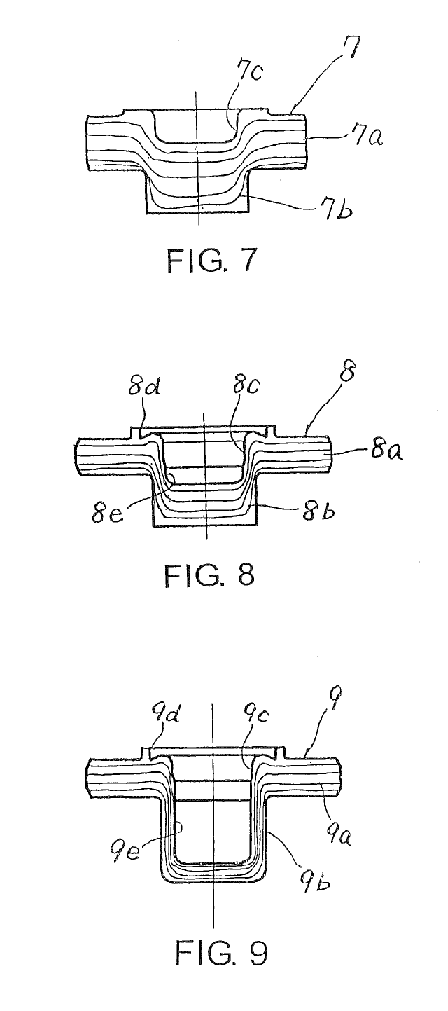

Then, at a second press station, the intermediate shaped component 7 is press-formed by upper and lower dies in a direction perpendicular to the fiber flow such that an intermediate shaped component 8 is formed to have a flange 8a including a central hole portion 8c and an outer edge engaging portion 8d, and a bottomed cylindrical portion 8b including a communicating hole 8e which extends outwardly from the center portion of an axial end of the flange 8a and communicates with the central hole portion 8c of the flange 8a as shown in FIG. 8.

Here, as shown in FIG. 8, the fiber flow of the intermediate shaped component 8 uninterruptedly flows in a substantially radial direction of the flange 8a.

Further, at a third press station, the intermediate shaped component 8 is press-formed by upper and lower dies in a direction perpendicular to the fiber flow such that a third intermediate shaped component 9 is formed to have a flange 9a which is of a predetermined thickness and includes a central hole portion 9c and an outer edge engaging portion 9d, and a bottomed cylindrical portion 9b which is of predetermined dimensions and includes a deep communicating hole 9e which extends outwardly from the center portion of an axial end of the flange 9a and communicates with the central hole portion 9c of the flange 9a as shown in FIG. 9 (third process).

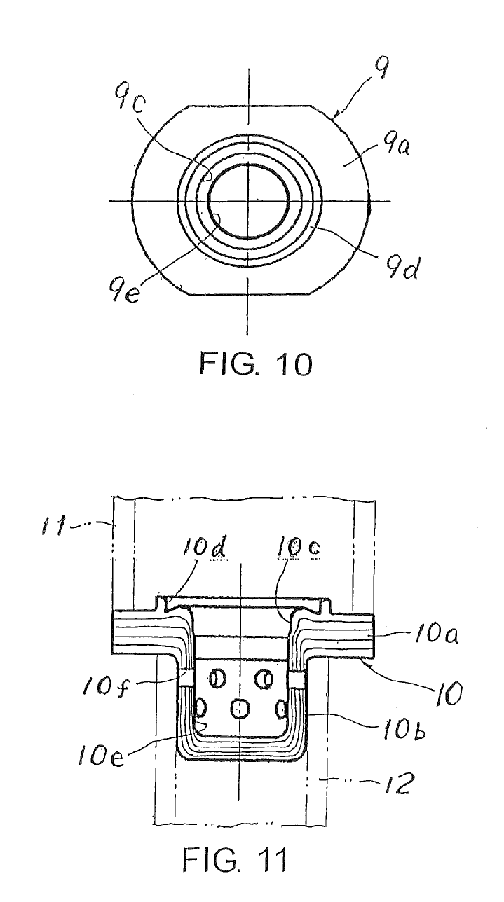

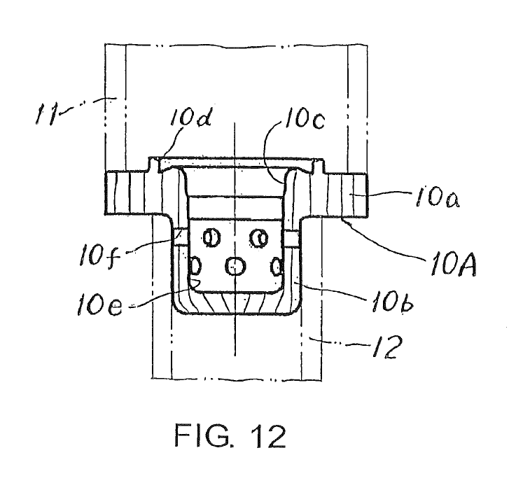

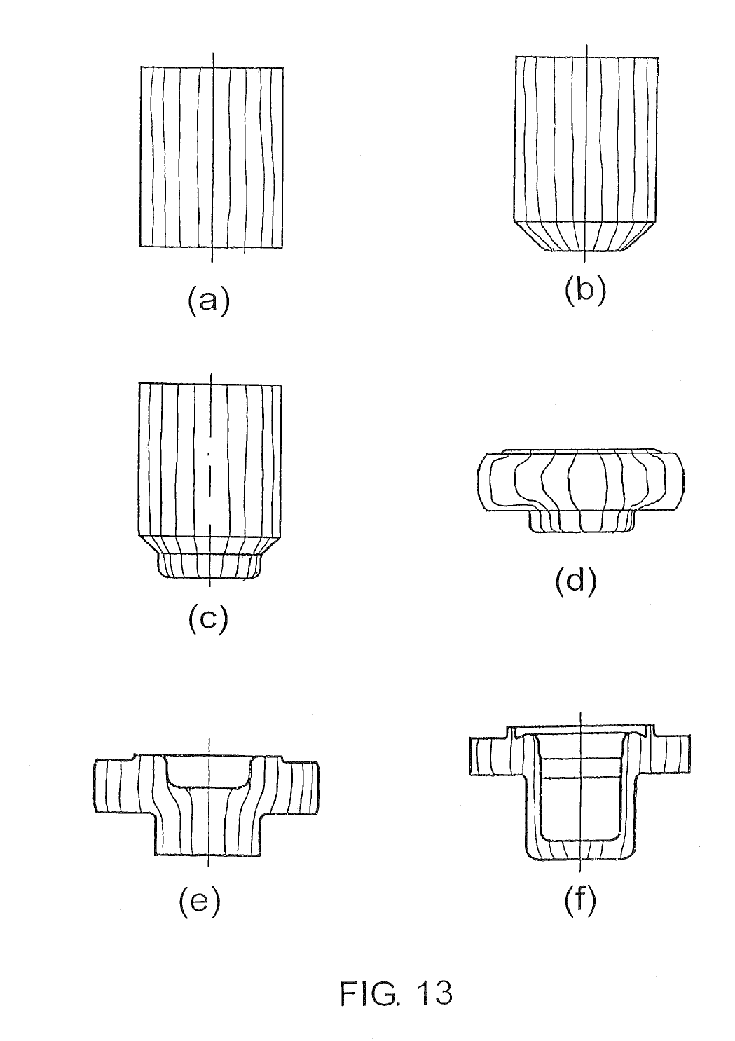

At a fourth press station, trimming is performed to trim both sides of the outer peripheral portion of the flange 9a of the third shaped component 9 to specified dimensions as shown in FIG. 10.

Here, as shown in FIG. 9, the fiber flow of the third shaped component 9 uninterruptedly flows in a substantially radial direction of the flange 8a.

Further, as shown in FIG. 11, a diffuser 10 as a finished product is formed by making two or more outlets 10f which penetrate in radial directions by a punching process in positions near to the bottom of the communicating hole 9e of the bottomed cylindrical portion 9b of the intermediate shaped component 9.

As shown by virtual lines in FIG. 11, the diffuser 10 formed as described above is attached to an opening of a high-pressure gas container 11 by welding at an outer edge surface of the flange 10a, while engaged to an airbag 12 at the outer circumference of the bottomed cylindrical portion 10b.

According to the diffuser 10 manufactured as described above, it is possible to completely prevent gas leakage from the flange 10a and bottomed cylindrical portion 10b by having the fiber flow uninterruptedly flowing in a substantially radial direction (horizontal direction in drawings) of the flange 10a when the diffuser 10 is attached to the high-pressure gas container 11 at the outer surface of the flange 10a. As a result, an inspection for the presence or absence of gas leakage at the flange 10a and bottomed cylindrical portion 10b after the manufacture of the diffuser 10 can be avoided. Not only because this inspection work can be avoided, but also because logical assurance is possible, the diffuser 10 can be safely and reliably used while keeping the cost low.

Further, in the above-described embodiments, low-cost mass-production is performed at first by forging from the solid material 1 to the second shaped component 6 by the multistage former. Then, high-accuracy press-forming is performed starting with the second shaped component 6 to the finished shaped component 10 by the vertical press. Therefore, by combining these processes, it becomes possible to manufacture a final product with high-accuracy while actively reducing the cost.

It should be noted that while a combination of multistage former and vertical press is desirable as described above, it is also possible to continuously process starting with the solid material 1 to the third shaped component 9, for example, by either one of the multistage former or press alone.

### REFERENCE NUMERALS

1 solid material,
4 first shaped component,
6 second shaped component,
6a flange,
6b cylindrical portion,
9 third shaped component,
9a flange,
9b bottomed cylindrical portion,
9c central hole portion,
9d outer edge engaging portion,
10 diffuser,
10a flange,
10b bottomed cylindrical portion,
10c central hole portion,
10d outer edge engaging portion,
10e communicating hole,
10f outlet

What is claimed is:

1. A method for manufacturing a diffuser comprising a flange including a central hole portion and an outer edge engaging portion, and a bottomed cylindrical portion including a communicating hole which is continuously provided at an axial end of the flange and communicates with the central hole, wherein a plurality of outlets extending in a radial direction are formed to communicate with an airbag in a lower portion of the communicating hole of the bottomed cylindrical portion, the method comprising:
a first process in which, by using a cylindrical solid material having a fiber flow extending in an axial direction in order to eliminate material loss, the cylindrical solid material is forged in an axial direction to form a first shaped component which has disk-shaped top and bottom surfaces and a flattened spindle-shape in side view;
a second process in which the first shaped component is rotated 90 degrees to be placed horizontal, and the horizontally placed first shaped component is forged in a direction perpendicular to the axial direction to form a second shaped component which has a flange with the fiber flow extending in a radial direction and a cylindrical portion continuously provided at an axial end of the flange; and
a third process in which the second shaped component is press-formed or forged in a direction perpendicular to the fiber flow to forma third shaped component which has a flange including a central hole portion and an outer edge engaging portion, and a bottomed cylindrical portion including a communicating hole which is continuously provided at an axial end of the flange and communicates with the central hole portion such that the fiber flow uninterruptedly flows in a substantially radial direction of the flange.
